(19) United States
(12) Patent Application Publication
(10) Pub. No.: US 2019/0279155 A1
(43) Pub. Date: Sep. 12, 2019

(54) METHOD, DEVICE AND SYSTEM FOR MONITORING ORDER DELIVERY ANOMALY BASED ON GIS TECHNOLOGY

(71) Applicants: BEIJING JINGDONG SHANGKE INFORMATION TECHNOLOGY CO., LTD., Haidian District, Beijing (CN); BEIJING JINGDONG CENTURY TRADING CO., LTD., Beijing (CN)

(72) Inventor: Xin BAI, Haidian District, Beijing (CN)

(21) Appl. No.: 16/319,118

(22) PCT Filed: Jul. 19, 2017
(86) PCT No.: PCT/CN2017/093447

§ 371 Date: Jan. 18, 2019

(30) Foreign Application Priority Data
Jul. 21, 2016 (CN) 201610576580.8

(51) Int. Cl. G06Q 10/08; G06F 16/29

(52) U.S. Cl. CPC G06Q 10/08355; G06F 16/29

(57) ABSTRACT

The present invention relates to a method, device and system for monitoring anomaly of an order proper-delivery based on GIS technology, capable of realizing the whole-process monitoring and tracking of the order delivery, and monitoring and giving an alarm for anomaly of the order proper-delivery based on a freight deviation of the order delivery calculated automatically. The monitoring method comprises: acquiring coordinates of order delivery trajectory points using GIS technology, the coordinates including latitudes, longitudes and time data of the trajectory points; generating trajectory data according to the coordinates of the trajectory points; according to the trajectory data, monitoring whether an anomaly is present in the order proper-delivery, and if so, recording information about the anomaly, wherein an offset between the coordinates of a proper-delivery point and coordinates of an order address is calculated, and the offset amount is compared with an offset threshold; if the offset amount doesn't exceed the offset threshold, the monitoring is ended, and if the offset amount exceeds the offset threshold, whether an actually generated freight exceeds a freight that should be paid for delivery to the order address is determined, and if so, information about the anomaly is recorded, and otherwise, the monitoring is ended.

### TECHNICAL FIELD

The present invention relates to the computer technology and software field, in particular to a method, device and system for monitoring anomaly of an order proper-delivery based on GIS technology.

### BACKGROUND ART

With the continuous improvement of the logistics and delivery capabilities in modern society, more and more merchants choose to use third-party carriers for goods delivery, which is increasingly common in the field of e-commerce. However, in the process of using third-party delivery, carriers repeatedly defraud the freight by means of virtual ordering, virtual delivery, and colluding with bulk virtual buyers with virtualized delivery addresses.

At present, the way to supervise anomaly of an order proper-delivery of third-party carriers is mainly based on complaint reporting and manual investigation. However, complaints and reports can only passively wait for others to report and expose, and cannot actively find out, and manual investigation requires large time and labor costs, and have a low success rate.

In view of the fact that there is no mechanism for automatically tracking the third party carrier's delivery behavior in real time and monitoring an abnormal proper-delivery order, it cannot effectively help merchants to avoid the risk and economic loss caused by the order freight fraud.

### SUMMARY OF THE INVENTION

In view of the above, the present invention provides a method, device and system for monitoring anomaly of an order proper-delivery based on GIS technology, capable of realizing the whole-process monitoring and tracking of the order delivery, and monitoring and giving an alarm for anomaly of an order proper-delivery based on a freight deviation of the order delivery calculated automatically.

To achieve the aforesaid object, in accordance with one aspect of the present invention, a monitoring method for anomaly of an order proper-delivery based on GIS technology is provided.

The monitoring method for anomaly of an order proper-delivery based on GIS technology according to the present invention, comprises: acquiring coordinates of order delivery trajectory points using GIS technology, the coordinates including latitudes, longitudes and time data of the trajectory points; generating trajectory data according to the coordinates of the trajectory points; calculating an offset between coordinates of a proper-delivery point and coordinates of an order address, and comparing the offset with an offset threshold; if the offset amount doesn't exceed the offset threshold, ending the monitoring, and if the offset amount exceeds the offset threshold, determining whether an actually generated freight exceeds a freight that should be paid for delivery to the order address in accordance with freight rules, and if yes, recording information about the anomaly, and otherwise, ending the monitoring.

Optionally, the method further comprises: prior to generating the trajectory data according to the coordinates of the trajectory points, performing abnormal point filtering for the acquired coordinates of the trajectory points.

Optionally, the method further comprises: acquiring the coordinates of order delivery trajectory points using GIS technology further comprises acquiring coordinates of branch delivery trajectory points and coordinates of home delivery trajectory points; and generating the trajectory data according to the coordinates of the trajectory points further comprises generating branch delivery trajectory data and home delivery trajectory data.

Optionally, the offset amount is an offset ratio that is a ratio of an offset distance to a total distance of the order delivery.

Optionally, the method further comprises: summarizing a record of abnormal proper-deliveries of a carrier periodically, and if a number of the abnormal proper-deliveries in a unit period exceeds an anomaly threshold, performing an alarm processing, wherein the alarm processing includes: pushing the record of abnormal proper-deliveries, the generated freight difference, an abnormal proper-delivery proportion and information about a single anomaly of the carrier in the unit period to monitoring personnel.

In order to achieve the above object, in accordance with another aspect of the present invention, a monitoring device for anomaly of an order proper-delivery based on GIS technology is provided.

The monitoring device for anomaly of an order proper-delivery based on GIS technology according to the present invention, comprises: an acquiring module for acquiring coordinates of order delivery trajectory points using GIS technology, the coordinates comprising latitudes, longitudes and time data of the trajectory points; a trajectory generating module for generating trajectory data according to the coordinates of the trajectory points; an anomaly monitoring module for monitoring whether the anomaly is present in the order proper-delivery, and if so, recording information about the anomaly, wherein an offset between the coordinates of a proper-delivery point and coordinates of an order address is calculated, and the offset amount is compared with an offset threshold; if the offset amount doesn't exceed the offset threshold, the monitoring is ended, and if the offset amount exceeds the offset threshold, whether an actually generated freight exceeds a freight that should be paid for delivery to the order address is determined, and if yes, information about the anomaly is recorded, and otherwise, the monitoring is ended

Optionally, the trajectory generating module is further used for: prior to generating the trajectory data according to the coordinates of the trajectory points, performing abnormal point filtering for the acquired coordinates of the trajectory points.

Optionally, the device is further used for: the acquiring module acquiring coordinates of order delivery trajectory points using GIS technology further comprises acquiring coordinates of branch delivery trajectory points and coordinates of home delivery trajectory points; and the trajectory generating module generating trajectory data according to the coordinates of the trajectory points further comprises generating branch delivery trajectory data and home delivery trajectory data.

Optionally, the offset amount is an offset ratio that is a ratio of an offset distance to a total distance of the order delivery.

Optionally, the device further comprises: an alarming module for summarizing a record of abnormal proper-deliveries of a carrier periodically, and if a number of the abnormal proper-deliveries in a unit period exceeds an anomaly threshold, performing an alarm processing, wherein the alarm processing includes: pushing the record of abnormal proper-deliveries, the generated freight difference, an abnormal proper-delivery proportion and information about a single anomaly of the carrier in the unit period to monitoring personnel.

The electronic device for anomaly of an order proper-delivery based on GIS technology according to the present invention, comprises: one or more processors; and a storing means for storing one or more programs, wherein when the one or more programs are performed by the one or more processors, the one or more processors implement the method according to any one of claims 1-5.

A computer readable medium, in which a computer program is stored, according to the present invention, wherein when the program is executed by a processor, any one of the above methods is implemented.

In order to achieve the above object, in accordance with another aspect of the present invention, a monitoring system for anomaly of an order proper-delivery based on GIS technology is provided.

The monitoring system for anomaly of an order proper-delivery based on GIS technology according to the present invention, comprises: a memory for storing instructions; and a processor configured to perform, in accordance with the instructions, steps of: acquiring coordinates of order delivery trajectory points using GIS technology, the coordinates including latitudes, longitudes and time data of the trajectory points; generating trajectory data according to the coordinates of the trajectory points; monitoring whether the anomaly is present in the order proper-delivery, and if so, recording information about the anomaly, wherein an offset between the coordinates of a proper-delivery point and coordinates of an order address is calculated, and the offset amount is compared with an offset threshold; if the offset amount doesn't exceed the offset threshold, the monitoring is ended, and if the offset amount exceeds the offset threshold, whether an actually generated freight exceeds a freight that should be paid for delivery to the order address is determined, and if yes, information about the anomaly is recorded, and otherwise, the monitoring is ended.

In accordance with the technical solution of the present invention, by using GIS technology to acquire coordinates of order delivery trajectory points, automatic tracking and monitoring of the delivery behavior can be realized; by judging whether the delivery trajectory has deviated and whether the delivery freight is abnormal, an occurrence of an abnormal behavior in the order delivery is automatically monitored; and by active early warning when the occurrence of abnormal conditions exceeds a set alarm threshold, the order delivery monitoring personnel can be promptly notified. Therefore, it can effectively help the merchants to avoid the risk and economic loss caused by the order freight fraud.

### BRIEF OF THE DRAWINGS

The drawings are for a better understanding of the invention and are not intended to be construed as limiting the invention:

FIG. 1 is a schematic diagram of main steps of a monitoring method for anomaly of an order proper-delivery based on GIS technology according to an embodiment of the present invention.

FIG. 2 is a specific flow of a monitoring method for anomaly of an order proper-delivery based on GIS technology according to an embodiment of the present invention.

FIG. 3 is a flow chart of anomaly monitoring in a monitoring method for anomaly of an order proper-delivery based on GIS technology according to an embodiment of the present invention.

FIG. 4 is a schematic diagram of main modules of a monitoring device for anomaly of an order proper-delivery based on GIS technology according to an embodiment of the present invention.

FIG. 5 is a schematic diagram of main parts of a system for monitoring anomaly of an order proper-delivery based on GIS technology according to an embodiment of the present invention.

FIG. 6 is an exemplary system architecture diagram to which an embodiment of the present invention may be applied.

FIG. 7 is a block diagram showing the structure of a computer system suitable for implementing a terminal device or a server according to an embodiment of the present invention.

### DETAILED DESCRIPTION OF THE INVENTION

The exemplary embodiments of the present invention are described with reference to the accompanying drawings, which include various details of the embodiments of the present invention for facilitating understanding, and shall be deemed to be only exemplary. Therefore, it will be apparent to those skilled in the art that various changes and modifications may be made to the embodiments described herein without departing from the scope and spirit of the present invention. Descriptions of well-known functions and constructions are omitted in the following description for clarity and conciseness.

The scheme for monitoring anomaly of an order proper-delivery based on GIS technology according to an embodiment of the present invention mainly involves realizing whole-process monitoring and tracking of the order delivery by means of GIS technology, and performing automatic deviation calculation and anomaly alarm of the order proper-delivery point according to the order trajectory acquired.

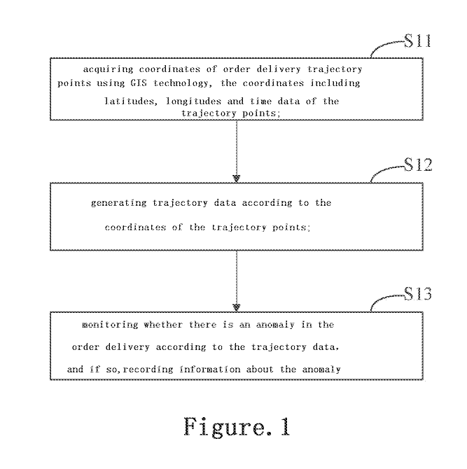

FIG. 1 is a schematic diagram of main steps of a monitoring method for anomaly of an order proper-delivery based on GIS technology according to an embodiment of the present invention.

As is shown in FIG. 1, the monitoring method for anomaly of an order proper-delivery based on GIS technology according to an embodiment of the present invention mainly comprises:

Step S11: acquiring coordinates of order delivery trajectory points using GIS technology, the coordinates including latitudes, longitudes and time data of the trajectory points;

Step S12: generating trajectory data according to the coordinates of the trajectory points;

Step S13: monitoring whether the anomaly is present in the order proper-delivery, and if so, recording information about the anomaly, wherein an offset between the coordinates of proper-delivery point and coordinates of order address is calculated, and the offset amount is compared with an offset threshold; if the offset amount doesn't exceed the offset threshold, the monitoring is ended, and if the offset amount exceeds the offset threshold, whether an actually generated freight exceeds a freight that should be paid for delivery to the order address is determined, and if so, information about the anomaly is recorded, and otherwise, the monitoring is ended.

In the existing logistics delivery process of carriers, there may be point-to-point delivery, that is, from a merchant directly to a customer. More often, staffs of a carrier includes branch delivery staffs and home delivery staffs. A branch delivery staffs receives goods from the merchants, and then delivers the goods to a site in customer's area. After the goods are sorted or distributed at the site, home delivery staffs continue delivering the goods from the site and to the customer's location. In this kind of delivery mode, the delivery from the merchant to the site in the customer's area can be called branch delivery, and staffs responsible for this delivery are called branch delivery staffs. The delivery from the site to the customer's location can be called home delivery, and staffs responsible for this delivery are called home delivery staffs.

Therefore, in the embodiment of the present invention, acquiring coordinates of order delivery trajectory points using GIS technology of step S11 may comprise acquiring coordinates of branch delivery trajectory points and coordinates of home delivery trajectory points; likewise, generating trajectory data according to the coordinates of the trajectory points in step S12 may comprise generating branch delivery trajectory data and home delivery trajectory data. Of course, the order trajectory points and the order trajectory can not only be strictly differentiated according to branch delivery or home delivery, but also can be determined as to whether to classify the order delivery process and how to classify it according to the specific carrying situations. Embodiments of the present invention are described in detail below by taking a joint point method of branch delivery and home delivery as an example.

In the process of order delivery, order distribution work will be carried out, and the order delivery tasks will be pushed to branch delivery staffs and home delivery staffs. In the process of branch delivery, a branch delivery staff will use a mobile device (for example, but not limited to, a mobile phone with delivery software installed) that supports order delivery operation and coordinate collection function, hereinafter referred to as “mobile APP”, for the order delivery operation. Similarly, in home delivery process, a home delivery staff also uses a mobile device (for example, but not limited to a POS machine) with a device that supports the order delivery operation and the coordinate collection function, hereinafter referred to as “POS machine” for the order delivery operation.

The specific process of acquiring coordinates of branch delivery trajectory points and coordinates of home delivery trajectory points in the foregoing step S11 is as follows: in the process of branch delivery, a branch delivery staff performs a receiving operation on the mobile APP, which represents the beginning of the branch transportation. In the process of branch transportation, the mobile APP collects and uploads the information about the coordinates of the trajectory points in the delivery trajectory in real time, including the longitudes, the latitudes and time information. Upon arriving at the site, the branch delivery staff performs a delivery operation on the mobile APP, indicating that the branch transportation is over.

In the process of home delivery, upon departing from the site with goods, a home delivery staff performs a receiving operation on the POS machine, indicating the beginning of home delivery. During home delivery process, the delivery staff collects and uploads through the POS machine the information about the coordinates of the trajectory points in the delivery trajectory in real time, including the longitudes, latitudes and time information. Upon arriving at the customer's location, the home delivery staff performs a delivery operation on the POS machine, indicating the end of the order delivery process.

In the above-mentioned delivery process, the mobile APP of the branch delivery staff and the POS machine of the home delivery staff are hardware devices for collecting and uploading real-time coordinates, wherein the time interval for coordinate collection and uploading can be set according to the data collection requirement.

The collected data is processed, calculated and then saved. The processing process includes: sorting the coordinate data uploaded by the mobile phone APP and the POS machine according to delivery staffs and time sequence, and storing the data in the cache. In addition, in the process of storing the coordinates, abnormal point filtering can be performed on the collected data. The abnormal point may be determined with, but is not limited to, a method of determining whether the Euclidean distance between the adjacent points exceeds the maximum travel distance, wherein if it exceeds the maximum travel distance, they are determined as abnormal points and the filtering is performed.

For example, suppose a sequence of geographical original trajectory points is T{p1, p2, . . . , pk}, and each point p(lt, lat, t) is a trajectory point, where lt, lat, and t represent the latitude, longitude and time information of the trajectory point recorded respectively. The abnormal point judgment is performed using the formula d(pᵢ₊₁, pᵢ) (tᵢ₊₁, tᵢ)>Vmax1, wherein pᵢ₊₁ represents the location of the (i+1)th point, tᵢ₊₁ represents the time of the (i+1)th point, and d(pᵢ₊₁, p₁) is the Euclidean distance between point pᵢ and pᵢ₊₁, (tᵢ₊₁, T) represents the time difference between two points, the division of the two represents the speed between the two points in a period of time, and Vmax1 is the maximum moving speed of the user. In the embodiment of the invention, Vmax1 is set to 160 km/h; if the formula is established, then pᵢ₊₁ is an abnormal point and removed.

The Euclidean distance for determining the abnormal point therein can be replaced by the moving distance between adjacent points, and any criteria that can remove the abnormal point can be used here.

So far, acquiring coordinates of order delivery trajectory points using GIS technology of step S11 has been completed, and the processing starts from step S12.

Upon completion of the proper-delivery of the order, a order delivery trajectory is generated according to the acquired time of the receiving operation by the order branch delivery staff and the home delivery staff and the time period of the proper-delivery combined with the coordinates of the valid delivery trajectory points of the delivery staffs during the time period, and is stored in the database. As described above, generating the order delivery trajectory in the embodiment of the present invention may include generating a branch delivery trajectory and a home delivery trajectory.

After the order trajectory is generated, whether or not there is an anomaly in the order delivery is monitored from step S13.

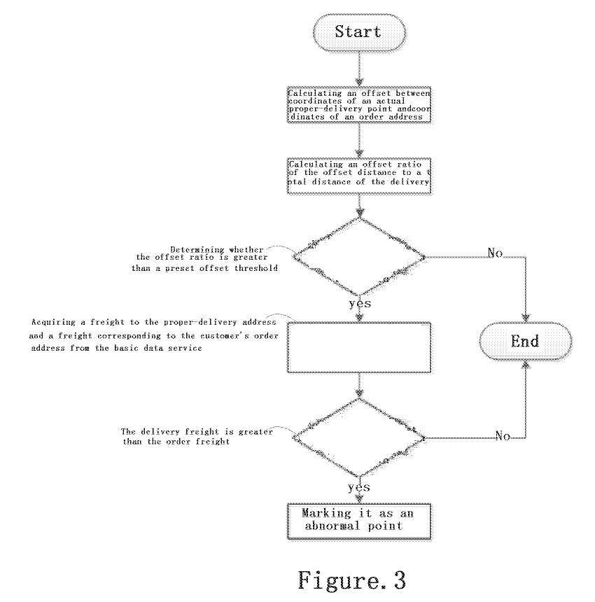

FIG. 3 is a flow chart of anomaly monitoring in a monitoring method for anomaly of an order proper-delivery based on GIS technology according to an embodiment of the present invention.

As shown in FIG. 3, the anomaly monitoring process in the monitoring method for anomaly of an order proper-delivery based on GIS technology according to an embodiment of the present invention is as follows:

First, upon completion of the order proper-delivery, the proper-delivery coordinates of the order are obtained according to proper-delivery time and delivery coordinate point; then an offset distance is generated by calculating the offset distance via the coordinates corresponding to the customer's order address and the coordinates of the actual delivery. The offset distance can be calculated with the following formula:

$$S = 2 arc sin \sqrt{{Sin}^{2} \frac{a}{2} + cos ( Lat 1 ) \times cos ( Lat 2 ) \times {Sin}^{2} \frac{b}{2}} \times 6378.137$$

1. Lat1 and Lung1 represent the longitude and latitude of point A, and Lat2 and Lung2 represent the longitude and latitude of point B;

2. a=Lat1−Lat2 is the difference in latitude of the two points, and b=Lung1−Lung2 represents the difference in longitude of the two points;

3. 6378.137 is the Earth radius in kilometers;

4. The calculation result is in kilometers.

The offset distance is presented by S, the order proper-delivery point is A, and the order placing point is B.

The offset in the embodiment of the present invention may be represented by an offset ratio that is a ratio of an offset distance to a total distance of the order delivery.

When the offset ratio>the offset threshold, the actually generated freight to the delivery address and the freight to the customer's order address are compared according to the carrier's freight rate information. If the former is larger than the latter, the order is marked as an abnormal proper-delivery order, and the information about the anomaly is recorded. If the former doesn't exceed the latter, the monitoring ends. The basic data such as the customer's order address are obtained through the order database system.

In addition, the monitoring method for anomaly of an order proper-delivery based on GIS technology according to the embodiment of the present invention further includes: periodically calculating a record of abnormal proper-deliveries of a carrier having abnormal proper-deliveries; and when in a certain period of time (for example, may be a unit period or a plurality of periods), the number of abnormal proper-delivery orders of a carrier exceeds the anomaly threshold (the anomaly threshold can be determined according to the monitoring requirements. For example, a unit period can be set to one month, and the anomaly threshold is 5 times of abnormal proper-deliveries in the unit period), triggering an alarm.

The alarm therein may be made by pushing alarm information to relevant monitoring personnel by means of mails, and the alarm content may include data such as the record of abnormal proper-deliveries, a freight difference generated, an abnormal proper-delivery proportion, and the actual delivery trajectory and the expected delivery trajectory of each of the abnormal proper-deliveries of the carrier in a certain period.

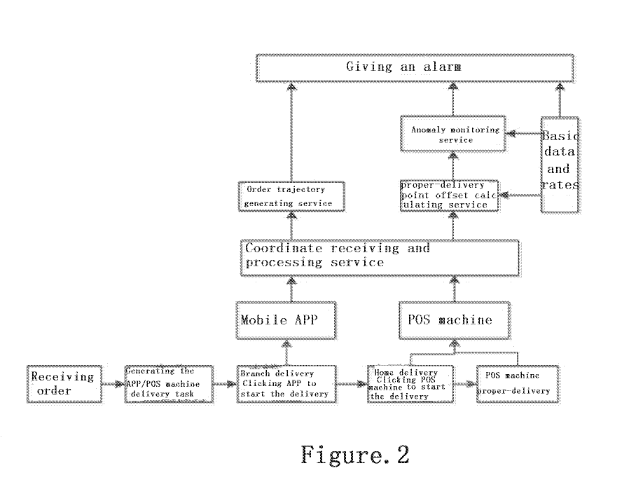

The above is a specific process of implementing the monitoring method for anomaly of an anomaly of an order proper-delivery based on GIS technology according to the embodiment of the present invention. For the detailed process, refer to FIG. 2.

As can be seen from the monitoring method for anomaly of an order proper-delivery based on GIS technology according to the embodiment of the present invention, by using GIS technology to acquire the coordinates of order delivery trajectory points, automatic tracking and monitoring of the delivery behavior can be realized; by judging whether the delivery trajectory has deviated and whether the delivery freight is abnormal, an occurrence of an abnormal behavior in the order delivery is automatically monitored; by active early warning when the occurrence of abnormal conditions exceeds a set alarm threshold, the order delivery monitoring personnel can be promptly notified. Therefore, it can effectively help the merchants avoid the risk and economic loss caused by the order freight fraud.

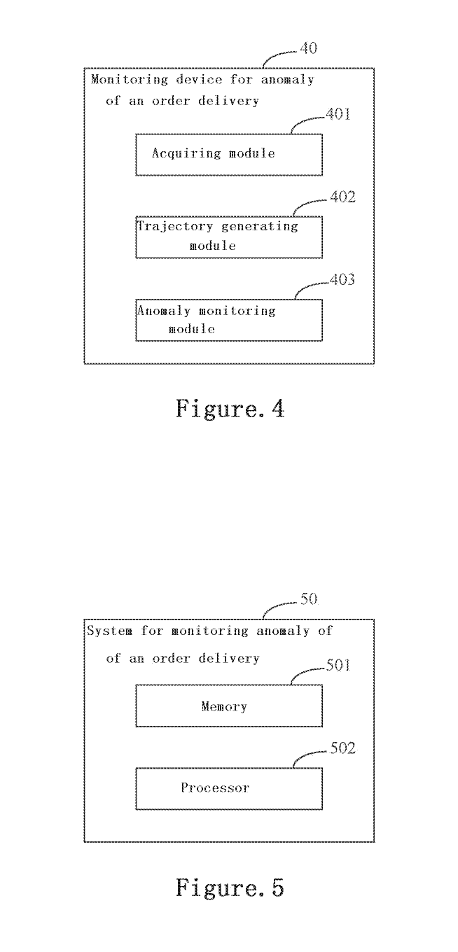

FIG. 4 is a schematic diagram of main modules of a monitoring device for anomaly of an order proper-delivery based on GIS technology according to an embodiment of the present invention.

As shown in FIG. 4, a device 40 for monitoring anomaly of an order proper-delivery based on GIS technology according to the embodiment of the present invention, comprises mainly the following: an acquiring module 401, a trajectory generating module 402 and an anomaly monitoring module 403, wherein

The acquiring module 401 is used for acquiring coordinates of order delivery trajectory points using GIS technology, the coordinates comprising latitudes, longitudes and time data of the trajectory points; the trajectory generating module 402 is used for generating trajectory data according to the coordinates of the trajectory points; and the anomaly monitoring module 403 is used for monitoring whether the anomaly is present in the order proper-delivery in accordance with the trajectory data, and if so, recording information about the anomaly, wherein an offset between the coordinates of a proper-delivery point and coordinates of an order address is calculated, and the offset amount is compared with an offset threshold; if the offset amount doesn't exceed the offset threshold, ending the monitoring, and if the offset amount exceeds the offset threshold, whether an actual freight exceeds a freight that should be paid for delivery to the order address is determined, and if so, recording information about the anomaly, and otherwise, ending the monitoring.

The trajectory generating module 402 is further used for performing abnormal point filtering for the coordinates of the trajectory points acquired prior to generating the trajectory data according to the coordinates of the trajectory points.

Besides, the device 40 is further used for: acquiring module 401 acquiring coordinates of order delivery trajectory points using GIS technology further comprises acquiring coordinates of branch delivery trajectory points and coordinates of home delivery trajectory points; and trajectory generating module 402 generating trajectory data according to the coordinates of the trajectory points further comprises generating branch delivery trajectory data and home delivery trajectory data.

The offset in the embodiment of the present invention may be measured by an offset ratio that is a ratio of an offset distance to a total distance of the order delivery.

Besides, the device 40 may further comprise: an alarming module (not shown in the drawings) for summarizing a record of abnormal proper-deliveries of a carrier periodically, and if a number of the abnormal proper-deliveries in a unit period exceeds an anomaly threshold, performing an alarm processing, wherein the alarm processing includes: pushing the record of abnormal proper-deliveries, the generated freight difference, an abnormal proper-delivery proportion and information about a single anomaly of the carrier in the unit period to monitoring personnel.

FIG. 5 is a schematic diagram of main parts of a system for monitoring anomaly of an order proper-delivery based on GIS technology according to an embodiment of the present invention.

As shown in FIG. 5, a system 50 for monitoring anomaly of an order proper-delivery based on GIS technology according to an embodiment of the present invention, comprises mainly the following: a memory 501 for storing instructions; and a processor 502 configured to perform, in accordance with the instructions, steps of: acquiring coordinates of order delivery trajectory points using GIS technology, the coordinates comprising latitudes, longitudes and time data of the trajectory points; generating trajectory data according to the coordinates of the trajectory points; monitoring whether the anomaly is present in the order proper-delivery in accordance with the trajectory data, and if so recording information about the anomaly, wherein an offset between the coordinates of a proper-delivery point and coordinates of an order address is calculated, and the offset amount is compared with an offset threshold; if the offset amount doesn't exceed the offset threshold, ending the monitoring, and if the offset amount exceeds the offset threshold, whether an actually generated freight exceeds a freight that should be paid for delivery to the order address is determined, and if so, recording information about the anomaly, and otherwise, ending the monitoring.

As can be seen from the above depictions, by using GIS technology to acquire the coordinates of order delivery trajectory points, automatic tracking and monitoring of the delivery behavior can be realized; by judging whether the delivery trajectory has deviated and whether the delivery freight is abnormal, an occurrence of an abnormal behavior in the order delivery is automatically monitored; and by active early warning when the occurrence of abnormal conditions exceeds a set alarm threshold, the order delivery monitoring personnel can be promptly notified. Therefore, it can effectively help the merchants to avoid the risk and economic loss caused by the order freight fraud.

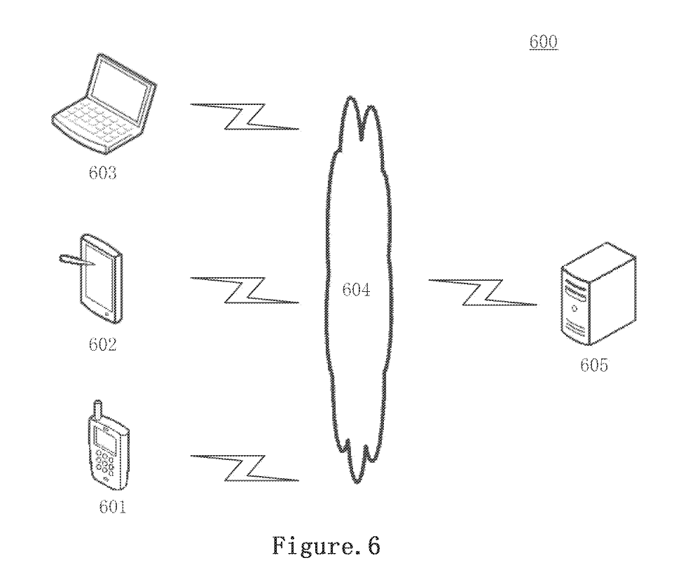

FIG. 6 is an exemplary system architecture diagram to which a monitoring method for anomaly of an order proper-delivery based on GIS technology or a monitoring device for anomaly of an order proper-delivery based on GIS technology according to an embodiment of the present invention may be applied.

As shown in FIG. 6, system architecture 600 may comprise terminal devices 601, 602, 603, a network 604 and a server 605. Network 604 is used for providing medium of a communication link between terminal devices 601, 602, 603 and server 605. Network 604 may comprise various types of connections, e.g., wired, wireless communication links, or fiber optic cables, and the like.

The user can interact with the server 605 via the network 604 using terminal devices 601, 602, 603 to receive or send messages and the like. Various communication client applications such as a shopping application, a web browser application, a search application, an instant communication tool, a mailbox client, a social platform software, and the like (for example only) can be installed on terminal devices 601, 602, and 603.

Terminal devices 601, 602, 603 can be various electronic devices having a display screen and supporting web browsing, including but not limited to smart phones, tablets, laptop portable computers, desktop computers, and the like.

Server 605 may be a server that provides various services, such as a background management server (for example only) that provides support for a shopping site browsed by a user using terminal devices 601, 602, 603. The background management server may analyze and process data such as a received query request for product information, and feed back the processing result (target push information, product information for example only) to the terminal devices.

It should be noted that the monitoring method for anomaly of an order proper-delivery based on GIS technology according to the embodiment of the present invention is generally executed by server 605. Accordingly, the monitoring device for order proper-delivery anomaly based on GIS technology is generally disposed in server 605.

It should be understood that the number of terminal devices, networks, and servers in FIG. 6 is merely illustrative. Depending on the implementation needs, there can be any number of terminal devices, networks, and servers.

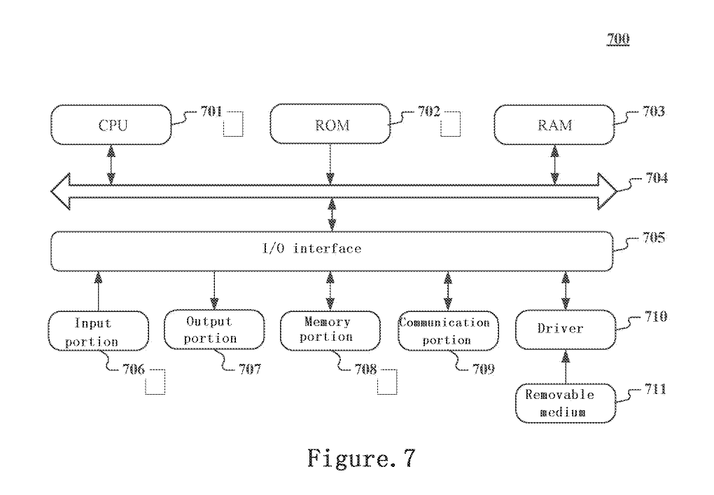

FIG. 7 below is a block diagram showing the structure of computer system 700 suitable for implementing a terminal device according to an embodiment of the present invention. The terminal device shown in FIG. 7 is only an example, and should not impose any limitation on the function and scope of use according to the embodiments of the present invention.

As shown in FIG. 7, a computer system 700 comprises central processing unit (CPU) 701 that can perform any proper actions and processes according to a program stored in read only memory (ROM) 702 or loaded in random access memory (RAM) 703 from storage portion 708. In RAM 703, various programs and data required for the operation of system 700 are also stored. CPU 701, ROM 702, and RAM 703 are connected to each other through bus 704. Input/output (I/O) interface 705 is also connected to bus 704.

The following components are connected to I/O interface 705 comprising: input portion 706 including a keyboard, a mouse, etc.; output portion 707 including a cathode ray tube (CRT), a liquid crystal display (LCD), and the like, and a speaker, etc.; storage portion 708 including a hard disk or the like; and communication portion 709 including a network interface card such as a LAN card, a modem, or the like. Communication section 709 performs communication processing via a network such as the Internet. Driver 710 is also connected to I/O interface 705 as needed. Removable medium 711, such as a magnetic disk, an optical disk, a magneto-optical disk, a semiconductor memory or the like, is mounted on drive 710 as needed so that a computer program read therefrom is installed into storage portion 708 as needed.

In particular, in accordance with the embodiment of the present disclosure, the processes described above with reference to the flowchart can be implemented as a computer software program. For example, the embodiments of the present invention include a computer program product comprising a computer program carried on a computer readable medium, the computer program comprising program codes for executing the method illustrated in the flowchart. In such an embodiment, the computer program can be downloaded and installed from the network via communication portion 709, and/or installed from removable media 711. When the computer program is executed by central processing unit (CPU) 701, the above-described functions defined in the system of the present invention are performed.

It should be noted that the computer readable medium shown in the present invention may be a computer readable signal medium or a computer readable storage medium or any combination of the two. The computer readable storage medium can be, for example, but not limited to, an electronic, magnetic, optical, electromagnetic, infrared, or semiconductor system, apparatus, or device, or any combination of the above. More specific examples of computer readable storage medium may include, but are not limited to, electrical connections having one or more wires, portable computer disks, hard disks, random access memories (RAM), read only memories (ROM), erasable programmable read only memories (EPROM or flash memories), optical fibers, portable compact disk read only memories (CD-ROM), optical storage devices, magnetic storage devices, or any suitable combination of the foregoing. In the present invention, a computer readable storage medium may be any tangible medium containing or storing a program that can be used by or in connection with instructions execution system, apparatus or device. In the present invention, a computer readable signal medium may include a data signal that is propagated in a baseband or as part of a carrier, in which computer readable program code is carried. Such propagated data signals can take a variety of forms including, but not limited to, electromagnetic signals, optical signals, or any suitable combination of the foregoing. The computer readable signal medium can also be any computer readable medium other than a computer readable storage medium, which can transmit, propagate, or transport a program for use by or in connection with the instructions execution system, apparatus, or device. Program code contained on a computer readable medium can be transmitted by any suitable medium, including but not limited to wireless, wire, fiber optic cable, RF, etc., or any suitable combination of the foregoing.

The flow chart and block diagrams in the drawings illustrate the architecture, functionality and operation of possible implementations of systems, methods and computer program products according to various embodiments of the invention. In this regard, each block of the flow chart or block diagrams can represent a module, a program segment, or a portion of code that includes one or more executable instructions for implementing prescribed logic functions. It should also be noted that in some alternative implementations, the functions noted in the blocks may also occur in a different order than the one illustrated in the drawings. For example, two successively represented blocks may in fact be executed substantially in parallel, and may sometimes be executed in the reverse order, depending upon the functionality involved. It is also noted that each block of the block diagrams or flowcharts, and combinations of blocks in the block diagrams or flowcharts, can be implemented in a dedicated hardware-based system that performs the specified function or operation, or can be implemented by a combination of dedicated hardware and computer instructions.

The modules involved in the embodiments of the present invention may be implemented by software or by hardware. The described modules may also be disposed in the processor. For example, it may be described as follows: A processor includes an acquiring module, a trajectory generating module, and an anomaly monitoring module. The names of these modules do not constitute a limitation on the modules themselves under certain circumstances.

Another aspect of the present invention also provides a computer readable medium, which may be included in the apparatus described in the above embodiments, or may be separately present and not incorporated in the apparatus. The computer readable medium carries one or more programs. When the one or more programs are executed by the device, the device is caused to comprise: acquiring coordinates of order delivery trajectory points using GIS technology, the coordinates including latitudes, longitudes and time data of the trajectory points; generating trajectory data according to the coordinates of the trajectory points; calculating an offset between coordinates of a proper-delivery point and coordinates of an order address, and comparing the offset with an offset threshold; if the offset amount doesn't exceed the offset threshold, ending the monitoring, and if the offset amount exceeds the offset threshold, determining whether an actually generated freight exceeds a freight that should be paid for delivery to the order address in accordance with freight rules, and if so, determining that an anomaly is present in the order proper-delivery and recording information about the anomaly, and otherwise, ending the monitoring.

In accordance with the technical solution of the present invention, by using GIS technology to acquire the coordinates of order delivery trajectory points, automatic tracking and monitoring of the delivery behavior can be realized; by judging whether the delivery trajectory has deviated and whether the delivery freight is abnormal, an occurrence of an abnormal behavior in the order delivery is automatically monitored; and by active early warning when the occurrence of abnormal conditions exceeds a set alarm threshold, the order delivery monitoring personnel can be promptly notified. Therefore, it can effectively help the merchants to avoid the risk and economic loss caused by the order freight fraud.

The above specific embodiments do not constitute a limitation of the scope of the present invention. Those skilled in the art will appreciate that a wide variety of modifications, combinations, sub-combinations and substitutions can occur depending on design requirements and other factors. Any modifications, equivalent substitutions, improvements, etc., made within the spirit and scope of the invention are intended to be included within the scope of the invention.

1. A monitoring method for anomaly of an order proper-delivery based on GIS technology, comprising:
acquiring coordinates of order delivery trajectory points using GIS technology, the coordinates including latitudes, longitudes and time data of the trajectory points;
generating trajectory data according to the coordinates of the trajectory points; and
calculating an offset between coordinates of a proper-delivery point and coordinates of an order address, and comparing the offset with an offset threshold, if the offset amount doesn't exceed the offset threshold, ending the monitoring, and if the offset amount exceeds the offset threshold, determining whether an actually generated freight exceeds a freight that should be paid for delivery to the order address in accordance with a freight rule, and if yes, determining that the anomaly is present in the order proper-delivery and recording information about the anomaly, and otherwise, ending the monitoring.

2. The monitoring method according to claim 1, further comprising:
prior to generating the trajectory data according to the coordinates of the trajectory points, performing abnormal point filtering for the acquired coordinates of the trajectory points.

3. The monitoring method according to claim 1, further comprising:
acquiring the coordinates of the order delivery trajectory points using GIS technology further comprises acquiring coordinates of branch delivery trajectory points and coordinates of home delivery trajectory points; and
generating the trajectory data according to the coordinates of the trajectory points further comprises generating branch delivery trajectory data and home delivery trajectory data.

4. The monitoring method according to claim 1, wherein the offset amount is an offset ratio that is a ratio of an offset distance to a total distance of the order delivery.

5. The monitoring method according to claim 1, further comprising:
summarizing a record of abnormal proper-deliveries of a carrier periodically; and
if a number of the abnormal proper-deliveries exceeds an anomaly threshold in a unit period, performing an alarm processing, wherein
the alarm processing includes: pushing the record of abnormal proper-deliveries, a generated freight difference, an abnormal proper-delivery proportion and information about a single anomaly of the carrier in the unit period to monitoring personnel.

6. A monitoring device for anomaly of an order proper-delivery based on GIS technology, comprising:
an acquiring module for acquiring coordinates of order delivery trajectory points using GIS technology, the coordinates comprising latitudes, longitudes and time data of the trajectory points;
a trajectory generating module for generating trajectory data according to the coordinates of the trajectory points;
an anomaly monitoring module for calculating an offset between the coordinates of a proper-delivery point and coordinates of an order address, and comparing the offset with an offset threshold; if the offset amount doesn't exceed the offset threshold, ending the monitoring, and if the offset amount exceeds the offset threshold, determining whether an actually generated freight exceeds a freight that should be paid for delivery to the order address in accordance with freight rules, and if yes, determining that the anomaly is present in the order proper-delivery and recording information about the anomaly, and otherwise, ending the monitoring.

7. The monitoring device according to claim 6, wherein the trajectory generating module is further used for:
prior to generating the trajectory data according to the coordinates of the trajectory points, performing abnormal point filtering for the acquired coordinates of the trajectory points.

8. The monitoring device according to claim 6, wherein the device is further used for:
the acquiring module acquiring the coordinates of order delivery trajectory points using GIS technology further comprises acquiring coordinates of branch delivery trajectory points and coordinates of home delivery trajectory points; and
the trajectory generating module generating the trajectory data according to the coordinates of the trajectory points further comprises generating branch delivery trajectory data and home delivery trajectory data.

9. The monitoring device according to claim 6, wherein the offset amount is an offset ratio that is a ratio of an offset distance to a total distance of the order delivery.

10. The monitoring device according to claim 6, wherein the device further comprises:
an alarming module for summarizing a record of abnormal proper-deliveries of a carrier periodically; and if a number of the abnormal proper-deliveries in a unit period exceeds an anomaly threshold, performing an alarm processing, wherein the alarm processing includes: pushing the record of abnormal proper-deliveries, the generated freight difference, an abnormal proper-delivery proportion and information about a single anomaly of the carrier in the unit period to monitoring personnel.

11. (canceled)

12. An electronic device for anomaly of an order proper-delivery based on GIS technology, comprising:
one or more processors; and
storing means for storing one or more programs, wherein
when the one or more programs are performed by the one or more processors, the one or more processors implement a monitoring method for anomaly of an order proper-delivery based on GIS technology, the method comprising:
acquiring coordinates of order delivery trajectory points using GIS technology, the coordinates including latitudes, longitudes and time data of the trajectory points;
generating trajectory data according to the coordinates of the trajectory points; and
calculating an offset between coordinates of a proper-delivery point and coordinates of an order address, and comparing the offset with an offset threshold, if the offset amount doesn't exceed the offset threshold, ending the monitoring, and if the offset amount exceeds the offset threshold, determining whether an actually generated freight exceeds a freight that should be paid for delivery to the order address in accordance with a freight rule, and if yes, determining that the anomaly is present in the order proper-delivery and recording information about the anomaly, and otherwise, ending the monitoring.

13. A computer readable medium, on which a computer program is stored, when the program is executed by a processor, implements a monitoring method for anomaly of an order proper-delivery based on GIS technology, the method comprising:
acquiring coordinates of order delivery trajectory points using GIS technology, the coordinates including latitudes, longitudes and time data of the trajectory points;
generating trajectory data according to the coordinates of the trajectory points; and
calculating, an offset between coordinates of a proper-delivery point and coordinates of an order address, and comparing the offset with an offset threshold, if the offset amount doesn't exceed the offset threshold, ending the monitoring, and if the offset amount exceeds the offset threshold, determining whether an actually generated freight exceeds a freight that should be paid for delivery to the order address in accordance with a freight rule, and if yes, determining that the anomaly is present in the order proper-delivery and recording information about the anomaly, and otherwise, ending the monitoring.

14. The electronic device according to claim 12, the method further comprising:
prior to generating the trajectory data according to the coordinates of the trajectory points, performing abnormal point filtering for the acquired coordinates of the trajectory points.

15. The electronic device according to claim 12, the method further comprising:
acquiring the coordinates of the order delivery trajectory points using GIS technology further comprises acquiring coordinates of branch delivery trajectory points and coordinates of home delivery trajectory points; and
generating the trajectory data according to the coordinates of the trajectory points further comprises generating branch delivery trajectory data and home delivery trajectory data.

16. The electronic device according to claim 12, wherein the offset amount is an offset ratio that is a ratio of an offset distance to a total distance of the order delivery.

17. The electronic device according to claim 12, the method further comprising:
summarizing a record of abnormal proper-deliveries of a carrier periodically; and
if a number of the abnormal proper-deliveries exceeds an anomaly threshold in a unit period, performing an alarm processing, wherein
the alarm processing includes: pushing the record of abnormal proper-deliveries, a generated freight difference, an abnormal proper-delivery proportion and information about a single anomaly of the carrier in the unit period to monitoring personnel.

18. The computer readable medium according to claim 13, the method further comprising:
prior to generating the trajectory data according to the coordinates of the trajectory points, performing abnormal point filtering for the acquired coordinates of the trajectory points.

19. The computer readable medium according to claim 13, the method further comprising:
acquiring the coordinates of the order delivery trajectory points using GIS technology further comprises acquiring coordinates of branch delivery trajectory points and coordinates of home delivery trajectory points; and
generating the trajectory data according to the coordinates of the trajectory points further comprises generating branch delivery trajectory data and home delivery trajectory data.

20. The computer readable medium according to claim 13, wherein the offset amount is an offset ratio that is a ratio of an offset distance to a total distance of the order delivery.

21. The computer readable medium according to claim 13, the method further comprising:
summarizing a record of abnormal proper-deliveries of a carrier periodically; and
if a number of the abnormal proper-deliveries exceeds an anomaly threshold in a unit period, performing an alarm processing, wherein
the alarm processing includes: pushing the record of abnormal proper-deliveries, a generated freight difference, an abnormal proper-delivery proportion and information about a single anomaly of the carrier in the unit period to monitoring personnel.
